(19) United States
(12) Patent Application Publication
(10) Pub. No.: US 2011/0046671 A1
(43) Pub. Date: Feb. 24, 2011

(54) ADJUSTABLE FLOW INFANT PACIFIER

(76) Inventor: Richard Okoturo, La Mesa, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 12/544,010

(22) Filed: Aug. 19, 2009

(51) Int. Cl. A61J 17/00; B23P 17/04

(52) U.S. Cl. 606/236; 29/428

(57) ABSTRACT

This application is directed towards a unique pacifier that will be able to contain small amounts of a variety of nourishments, including medications, with varying viscosities delivering them through a manually adjustable means controlling the flow rate into the nipple. By using a collapsible bag to contain the nourishment, it eliminates the possibility of the infant ingesting air. This pacifier has been designed with more than ample clearance in the area of the nose along with large openings in the sides where the infant can breathe if there is any problem breathing through the nose.

### FIELD OF THE INVENTION

This application is directed towards pacifiers used to satisfy an infant's need to continue the comforting process of sucking on the mother's breast after the need for nourishment has been fulfilled.

### BACKGROUND OF THE INVENTION

For many years, pacifiers have been used by parents to calm and satisfy infants between meals freeing them to perform the many other necessary tasks in the caring for the infant. Pacifiers are also used to calm infants when they are stressed or just to keep them occupied between meals. Normally no nourishment is given through the pacifiers because they were a sealed unit. Attempts have been made to design a variety of different pacifiers used to deliver medication without a lot of success. Major problems have come about that when the infants have removed the material from the pacifiers; they suck air, which creates the problem.

Pacifiers must be designed so that the infant can easily breathe around them along with being able to discharge them from their mouth if they desire, so they must be small and light weight. When infants are given a bottle for nourishment, they are generally held by their parents to control the feeding process and make sure that the infant does not choke The nourishment in the bottle is generally in a liquid form and controlled by the orifice in the end of the flexible nipple with no other flow metering capabilities. In the past with rigid infant bottles, the infant would have to release the nipple to let the air flow back into the bottle to replace the liquid. Problems will often occur during this process when the infant would ingest air and become very uncomfortable requiring the parent to hold the infant up and pat them on the back to release the bubble. More recently infant bottles have been designed with a flexible bag that shrinks when the liquid is sucked out by the infant. As infants grow older, they often reject various foods because they have not become familiar with their differing flavors. In the past, it has been impossible to introduce the infants to a very small amount of different flavor nourishments through an adjustable orifice into the nipple of a bottle or pacifier.

This application is directed towards a unique pacifier that will be able to contain small amounts of a variety of nourishments, including medications, with varying viscosities delivering them through a manually adjustable means controlling the flow rate into the nipple. By using a collapsible bag to contain the nourishment, it eliminates the possibility of the infant ingesting air. This pacifier has been designed with more than ample clearance in the area of the nose along with large openings in the sides where the infant can breathe if the nose is clogged with congestion.

Numerous innovations for the infant pacifiers have been provided in the prior art that are described as follows. Even though these innovations may be suitable for the specific individual purposes to which they address, they differ from the present design as hereinafter contrasted. Tile following is a summary of those prior art patents most relevant to this application at hand, as well as a description outlining the difference between the features of the Adjustable Flow Infant Pacifier and the prior art.

U.S. Pat. No. 2,959,314 of Albert Sanchez describes a nipple for a baby bottle and more particularly involves an improved valve structure for a nipple as well as an improved nipple. According to the invention there is provided a valve for a nipple which insures a more steady flow of liquid such as water, milk, food juices, etc., from a nipple or diaphragm having a plurality of holes, and a valve plug adapted in one position to close the holes and in another position to open the holes. The diaphragm carries the valve plug and is operated by the air pressure or suction applied first to one side of the diaphragm and then to the other side thereof. In an improved form of the invention, the nipple is provided with a massive resilient body and a narrow passage for liquid. This body resists compression to maintain a more even flow of liquid from the nipple.

This patent describes a nipple for a baby bottle with a valve structure having a diaphragm that is operated by the air pressure or suction applied first to one side and then to the other. This application deals primarily with a baby bottle and has no adaptation to be used as a pacifier and does not have a means of manually adjusting the flow of the nourishment. It also does not address the problem of the baby ingesting air in the feeding process.

U.S. Pat. No. 5,123,915 of Lawrence E. Miller et al. pertains to a device for the oral administration of a medication. The device comprises a pierced nipple having a nipple chamber and an open base, a medication reservoir having an outer wall member defining a reservoir chamber, a first end opening into the reservoir chamber, and a closable second end opening into the reservoir chamber. There is means to connect the reservoir to the base of the nipple in fluid-tight relationship with the nipple chamber communicating with the reservoir chamber through the open base. There are closing means for sealing the second end of the reservoir

This patent describes an invention that pertains to the administration of a medication only and has no means of manually adjusting the flow of the medication. It leaves air in the nipple that the infant may ingest and does not leave ample openings in the area of the nose or on the sides for the infant to breath.

U.S. Pat. No. 5,176,705 of Davie E. Noble describes an infant's pacifier that is constructed in a manner to confine and administer a beneficial liquid composition. The pacifier has a hollow nipple having at its open upper extremity an outwardly directed flange. The nipple is held within a cylindrical sleeve centered in a base panel. The flange rests in abutment with a flat terminal rim of the sleeve. The sleeve is threadably engaged by a cap having a closure panel adapted to compress the flange against the flat rim, thereby sealing the nipple in a fluid-impermeable manner. The closure panel has provision for admitting a controlled amount of air to the nipple.

This patent describes a pacifier that is constructed in a manner to confine and administer a beneficial liquid composition that may include liquid nourishment. It does indicate that it may contain a perforation and valve mechanism for the passage of controlled amounts of air to replace the liquid composition, but does not address the fact that when the liquid composition is gone that the infant will be sucking air which can create a problem. It also does not provide a means to control the rate of flow of the liquid composition.

U.S. Pat. No. 5,611,622 of Mac Wang describes a temperature detection probe of a digital thermometer that may be detachably disposed within a pacifier nipple by forcibly inserting a coupling rod having a rounded split head, which carries the probe through a stub tube having a circular bottom plate securing the base of the nipple to a base plate. A cover is provided for enclosing the nipple when the pacifier is not being used.

This patent describes a pacifier incorporating a digital thermometer but does not have the capability of delivering a medication or nourishment through an orifice in the nipple end. It does have adequate area at the sides for the infant to breath through the mouth if necessary but does not leave enough clearance in the area of the nose.

U.S. Pat. No. 5,954,749 of Valerie M. Fields et al. discloses a mesh pacifier and associated clip attachment including a shield comprised of a peripheral rim dimensioned for surrounding a mouth of a baby. A nipple portion extends forwardly from the shield. A handle portion extends rearwardly from the shield. A plurality of sections of apertures are formed through the shield.

This patent describes the design and construction of a mesh pacifier clearly indicating the need for adequate open area around the mouth and nose for the infant to be able to breathe easily. This invention has not been designed to supply nourishment or medication to the infant.

While the prior patents and prior art commercial devices have been successful to a certain extent, it is nonetheless clear that substantial room exists for affecting an advancement in the art, which overcomes these shortcomings in a practical and efficient manner.

In this respect, before explaining at least one embodiment of the Adjustable Flow Infant Pacifier in detail it is to be understood that the design is not limited in its application to the details of construction and to the arrangement, of the components set forth in the following description or illustrated in the drawings. The Adjustable Flow Infant Pacifier is capable of other embodiments and of being practiced and carried out in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other structures, methods and systems for carrying out the several purposes of the present design. It is important, therefore, that the claims be regarded as including such equivalent constriction insofar as they do not depart from the spirit and scope of the present application.

### SUMMARY OF THE INVENTION

The principal advantage of the Adjustable Flow Infant Pacifier is that an infant can receive small amounts of nourishment including medications.

Another advantage of the Adjustable Flow Infant Pacifier is that it can be changed to deliver varying viscosities of nourishment by the means of a simple adjustment.

Another advantage of the Adjustable Flow Infant Pacifier is that it can be changed to deliver the nourishment or medications at different flow rates.

Another advantage of the Adjustable Flow Infant Pacifier is that it uses a collapsing bag for the nourishment minimizing the ingestion of air by the infant.

Another advantage is that an adjustable orifice plate within the Adjustable Flow Infant Pacifier has four separate locking positions.

Another advantage of the Adjustable Flow Infant Pacifier is that when the parts are assembled with the collapsing bag full of the nourishment or medication, the tab on the orifice plate goes into the collapsing bag and forces the nourishment through the orifices and into the nipple central cavity. This removes the air in that area and keeps the infant from ingesting any air.

Another advantage of the Adjustable Flow Infant Pacifier is that the infant cannot suck air after the collapsible bag is completely empty.

Another advantage of the Adjustable Flow Infant Pacifier is that it has been designed with more than ample clearance in the area of the nose along with large openings in the sides where the infant can breath easily if the nose is clogged with congestion.

Yet another advantage of the Adjustable Flow Infant Pacifier is that it can be easily taken apart and cleaned or sterilized.

And still another advantage of the Adjustable Flow Infant Pacifier is that a music box cover can snap over the cap section as an alternate embodiment of the device.

These together with other advantages of the Adjustable Flow Infant Pacifier, along with the various features of novelty, which characterize the design, are pointed out with particularity in the claims annexed to and forming a part of this disclosure. For a better understanding of the Adjustable Flow Infant Pacifier, its operating advantages and the specific objects attained by its uses, reference should be made to the accompanying drawings and descriptive matter in which there are illustrated preferred embodiments of the Adjustable Flow Infant Pacifier. There has thus been outlined, rather broadly, the more important features of the design in order that the detailed description thereof that follows may be better understood, and in order that the present contribution to the art may be better appreciated. There are additional features of the Adjustable Flow Infant Pacifier that will be described hereinafter and which will form the subject matter of the claims appended hereto.

The unique design of the Adjustable Flow Infant Pacifier consists of a threaded main body member incorporating a faceplate with breathing orifices on the side and ample clearance in the area of the nose. An orifice in the center provides for the installation of the flexible nipple. The flexible nipple although similar to a standard nipple, has been designed with a small orifice in the end and a central cavity that has been reduced in size from the standard nipple. When the flexible nipple is inserted into the threaded main body member the flange seats against a flat surface with a mating circular “V” groove to supply additional sealing capabilities along with a engaging lip that secures the nipple in place as it is inserted through the orifice in the threaded body member. A tapered opening at the distal end adjacent to the mounting flange provides flow of the nourishment or medication from the off-center orifice in the metering plate. The metering plate is located against the flange of the nipple. Adjacent to the metering plate is the adjustable orifice plate where one of four orifices of differing sizes matches up with the single off-center orifice in the metering plate. Both the metering plate and the adjustable orifice plate are registered in four angular slots in the threaded main body member.

Changes in orifice size are made by lifting the adjustable orifice plate off the metering plate by the means of a lifting tab and rotating so that the desired orifice lines up with the off-center orifice in the metering plate. A collapsible bag with a flange at the opening is used to contain the nourishment or medication. The collapsible bag is inserted into the central cavity of the threaded cap section of the Adjustable Flow Infant Pacifier and rotated down into the threaded main body member until it seats firmly. The air in the threaded main body member is forced out through the orifice in the end of the nipple and as the lifting tab is forced into the nourishment or medication that material is transferred into the central cavity of the nipple removing all the air within the device. An orifice is located at the top of the cap section to allow air to enter and the collapsible bag to shrink, while the flange at the opening of the collapsible bag maintains the seal so air cannot enter the nipple. By using the collapsible bag for the nourishment or medication, the infant is not capable of ingesting air even after the collapsible bag is empty. A protrusion with an orifice at the top outer surface of the cap section provides for a conventional ring or a holding string. The collapsible bags can be filled with the nourishment or medication by the individual caring for the infant or they may be available as a sealed commercially available unit in a variety of contents and sizes.

An alternate embodiment of the Adjustable Flow Infant Pacifier will incorporate a music box cover that will snap over the fluted portion of the cap section. The music box cover will have a protrusion with an orifice at the top outer surface of the cap section provides for a conventional ring or a holding string. The battery will be sealed within the music box cover and this portion will be disposable when the battery is dead.

With respect to the above description then, it is to be realized that the optimum dimensional relationships for the parts of this application, to include variations in size, materials, shape, form, function and manner of operation, assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the Adjustable Flow Infant Pacifier. Further, since numerous modifications and changes will readily occur to those skilled in the art, it is not desired to limit the design to the exact construction and operation shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate embodiments of the Adjustable Flow Infant Pacifier and together with the description, serve to explain the principles of this application.

FIG. 1 depicts a side view of the Adjustable Flow Infant Pacifier

FIG. 2 depicts an exploded view of the Adjustable Flow Infant Pacifier

FIG. 3 depicts a cross section of the assembled Adjustable Flow Infant Pacifier

FIG. 4 depicts an exploded side view of the Adjustable Flow Infant Pacifier with portions shown in cross section.

FIG. 5 depicts a top view of the adjustable orifice plate of the Adjustable Flow Infant Pacifier.

FIG. 6 depicts a top view of the metering plate of the Adjustable Flow Infant Pacifier.

FIG. 7 depicts a side view of the alternate embodiment of the Adjustable Flow Infant Pacifier incorporating a music box cover.

FIG. 8 depicts a cross section of the alternate embodiment of the Adjustable Flow Infant Pacifier incorporating a music box cover.

For a fuller understanding of the nature and advantages of the Adjustable Flow Infant Pacifier, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

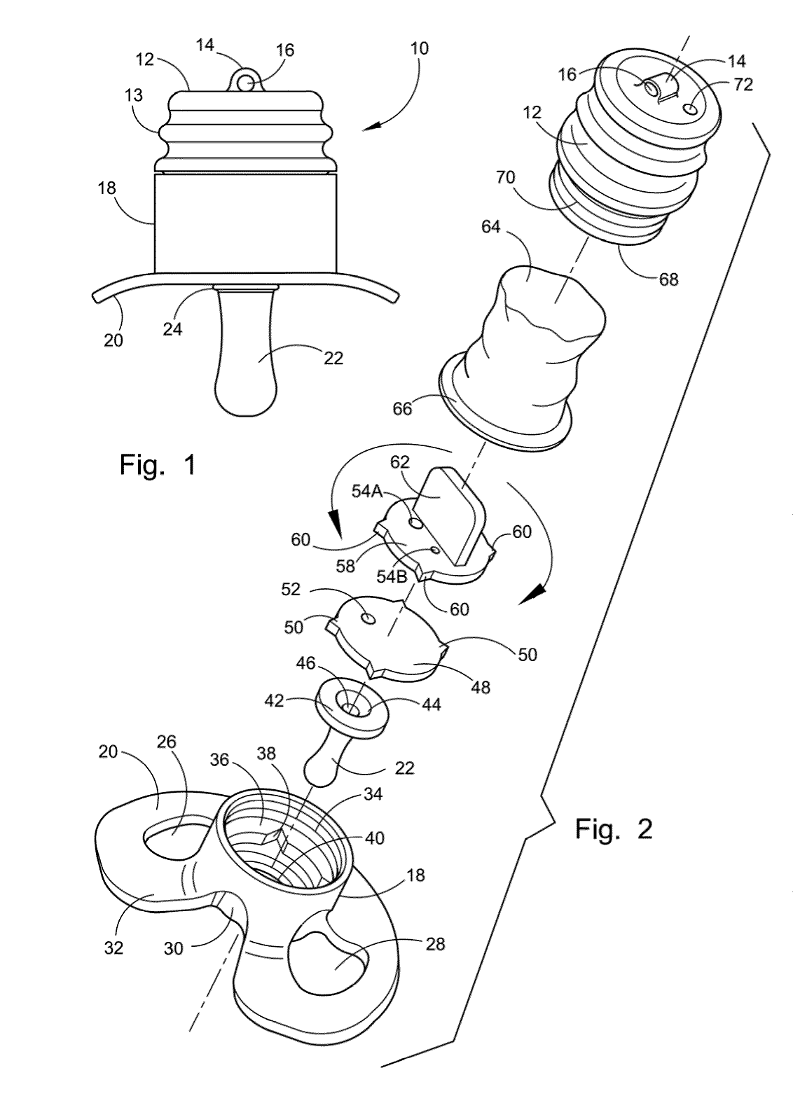

Referring now to the drawings, wherein similar parts of the Adjustable Flow Infant Pacifier 10 are identified by like reference numerals. There is seen in FIG. 1 a side view of the Adjustable Flow Infant Pacifier 10 depicting the threaded cap section 12 with the protrusion 14 at the top with the orifice 16 for the insertion of a conventional ring or a holding string. A fluted section 13 is on the upper surface. The threaded main body member 18 is shown with the faceplate 20 extending on either side. The nipple 22 is shown extending downwardly and being held in place by the means of the nipple engaging lip 24 that secures the nipple in place.

FIG. 2 depicts an exploded view of the Adjustable Flow Infant Pacifier 10 illustrating the threaded main body member 14 with the faceplate 20 extending to either side incorporating the two breathing orifices 26 and 28. The nose relief 30 in the forward area 32 of the faceplate 20 has been designed to leave adequate breathing area for the infant's nose. At the termination of the female threads 34 within the threaded main body member 14 there is a circular shelf 36 with four equally spaced angular slots 38 followed by the central orifice 40 where the nipple goes through. The nipple 22 is displayed with the mounting flange 42 and the tapered opening 44 leading to the central cavity 46. The circular metering plate 48 is shown above the nipple 22 with four equally spaced angular shaped locators 50 that register in the angular slots 38 in the threaded main body member 18 holding the metering plate 48 in a fixed position. Orifice 52 in the metering plate 48 lines up directly with one of the four orifices 54A, 54B, 54C and 54D in tile adjustable orifice plate 58 when the angular shaped locators 60 are positioned in the angular slots 38 over the metering plate 48 within the threaded main body member 18. The adjustable orifice plate 58 will have four orifices 54A, 54B, 54C and 54D of different sizes depending upon the viscosity or the desired flow of the nourishment of medication. The off-center orifice 52 in the metering plate 48 will be as large or larger than the largest of the four orifices 54A, 54B, 54C and 54D in the adjustable orifice plate 58. The adjustable orifice plate 58 incorporates a tab 62 used to raise the adjustable orifice plate 58 to rotate it to a different position. The total area of the tab 62 will be equal to the area of the central cavity 46 in the nipple so that when the device is closed the tab 62 will extrude some of the nourishment or medication into the central cavity 46 of the nipple 22 removing all the air in that area. The nourishment or medication will be placed within the collapsible bag 64 that is equipped with a sealing flange 66.

The collapsible bag 66 is inserted into the central cavity 68 of the threaded cap section 12 of the Adjustable Flow Infant Pacifier 10 and rotated down with the threads 70 into the threaded main body member 18 until it seats firmly. The air in the threaded main body member 18 is ejected through the orifice in the end of the nipple 22 as the lifting tab 62 is forced into the nourishment or medication. An orifice 72 is located at the top of the threaded cap section 12 to allow air to enter and the collapsible bag 64 to shrink, while the flange 66 at the opening of the collapsible bag 64 maintains the seal so air cannot enter the nipple. By using the collapsible bag 64 for the nourishment or medication, the infant is not capable of ingesting air even after the collapsible bag 64 is empty. A protrusion 14 with an orifice 16 at the top outer surface of the threaded cap section 12 is provided for a conventional ring or a holding string.

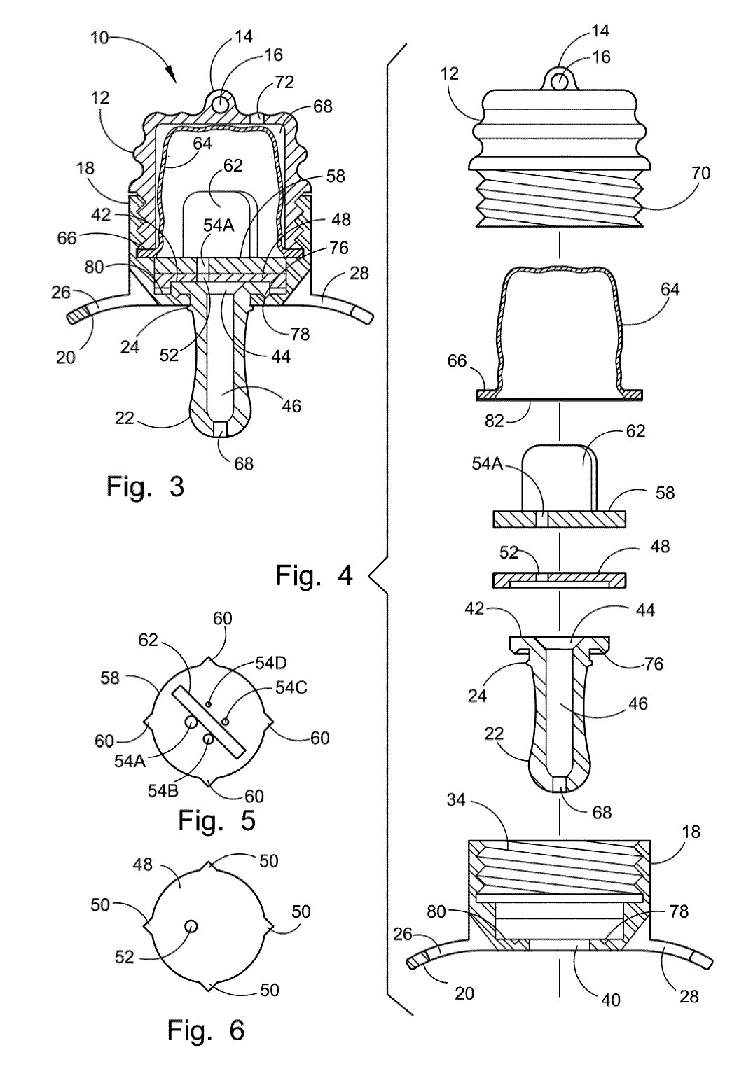

FIG. 3 depicts a cross section of the assembled Adjustable Flow Infant Pacifier 10 where the small orifice 68 is visible entering into the central cavity 46 in the distal end of the nipple 22. The nipple engaging lip 24 abuts the front of the faceplate 20. The nipple mounting flange 42 having a circular “V” configuration 76 locates within a circular “V” groove 78 in the lower surface 80 of the threaded main body member 18 further secures the nipple 22 and increasing the sealing capability. The orifice 54A in the adjustable orifice plate 58 is shown in alignment with the orifice 52 in the metering plate 48 and the tapered opening 44 in the nipple 22 providing a direct flow of the nourishment or medication. The flange 66 of the collapsible bag 64 is illustrated being compressed making an airtight seal between the threaded main body member 18 and the threaded cap section 12.

FIG. 4 depicts an exploded side view of the Adjustable Flow Infant Pacifier 10 with portions shown in cross section. The threaded cap section 12 shown in side view is shown with the protrusion 14 at the top containing the orifice 16 that provides for a conventional ring or a holding string, and the male threads 70 at the bottom. The collapsible bag 64 shown in cross section has the flange 66 on the lower surface. When the collapsible bags 64 are commercially available with a variety of nourishments or medications in they will be sealed by a thin membrane 82 across the surface of the flange 66. The adjustable orifice plate 58 is shown in cross section illustrating the tab 62 and one of the orifices 54A along with the metering plate 48 and the off center orifice 52. The nipple 22 is shown in cross section illustrating the location of the circular “V” configuration 76 on the lower surface of the mounting flange 42 and the nipple engaging lip 24. Below the nipple 22 is the threaded body member 18 with the internal female threads 34 further depicting the location of the circular “V” groove 78 on the lower surface 80 of the threaded body member 18. The location of the nipple orifice 40 is clearly visible in this illustration.

FIG. 5 depicts a top view of the adjustable orifice plate 58 of the Adjustable Flow Infant Pacifier 10 showing the location of the four orifices 54A, 54B, 54C and 54D and their varying sizes along with the lifting tab 62. The angular shaped locaters 60 are equally spaced around the perimeter of the adjustable orifice plate 58.

FIG. 6 depicts a top view of the metering plate 48 of the Adjustable Flow Infant Pacifier 10 depicting the location of the off center orifice 52. The angular shaped locaters 50 are additionally equally spaced around the perimeter of the metering plate 50 matching those on the adjustable orifice plate 58.

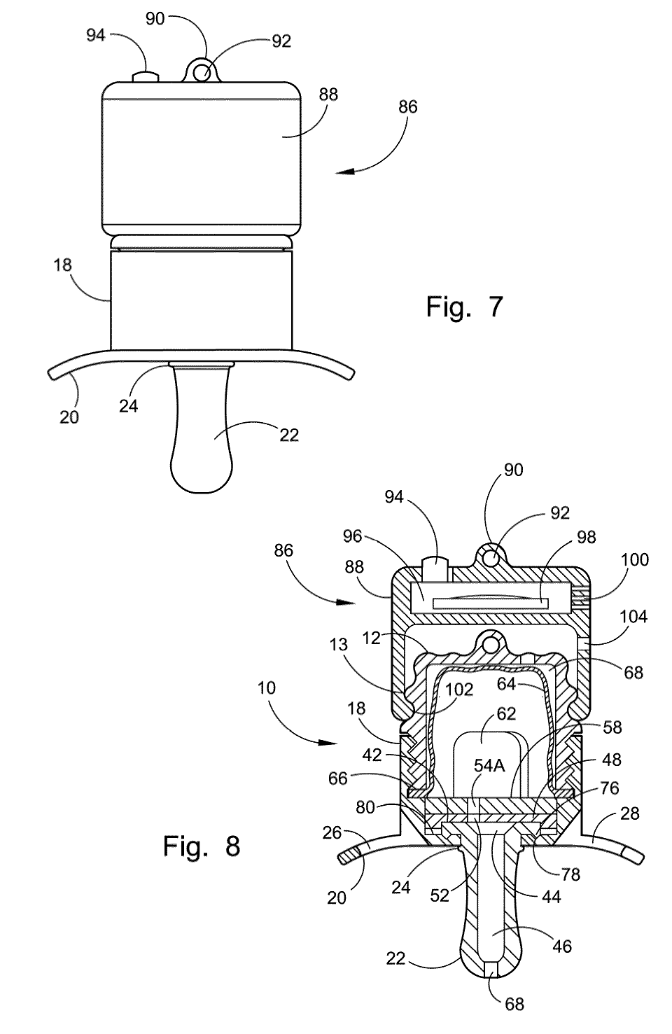

FIG. 7 depicts a side view of the alternate embodiment of the Adjustable Flow Infant Pacifier 86 incorporating a music box cover 88 with a protrusion 90 having an orifice 92 at the top. FIG. 8 depicts a cross section of the alternate embodiment of the Adjustable Flow Infant Pacifier 88 incorporating a music box cover where a switch 94 will activate the music box 96 and the battery 98 is sealed inside the unit. Orifices 100 in the side of the music box cover 88 will emit the sounds. The lower lip 102 of the music box cover 88 will engage with the flutes 13 on the cap section 12. It must be understood that a number of conventional attachment means would attach the music box cover 88 to the main body member 18 and will be covered within the scope of this application. An addition breather orifice 104 in the side of the music box cover will allow the air to enter the central cavity 68 when the nourishment is removed.

The Adjustable Flow Infant Pacifier 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a Adjustable Flow Infant Pacifier 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. An adjustable flow infant pacifier comprising:
(a) a male threaded cap section and a female threaded main body member having a faceplate extending to either side of said faceplate incorporating two breathing orifices and forming a nose relief portion in the forward area said faceplate;
(b) a circular shelf with two or more equally spaced angular slots and a central orifice located at the termination of said female threads;
(c) a nipple going through the threaded main body member wherein said nipple is displayed with a mounting flange and a tapered opening leading to a central cavity;
(d) a circular metering plate having a single off-center orifice located above said nipple and having two or more equally spaced angular shaped locators that register in said two or more equally spaced angular slots in said threaded main body member whereby said metering plate is held in a fixed position; and
(e) an adjustable orifice plate having two or more orifices of different sizes capable of flow adjustment by turning said adjustable orifice plate using said lifting tab and lining up the desired orifice in said adjustable orifice plate with said off-center orifice in said metering plate;
whereby said off-center orifice lines tip directly with one of the two or more orifices in the adjustable orifice plate when said angular shaped locators are positioned in said angular slots over said metering plate within said threaded main body member.

2. The adjustable flow infant pacifier according to claim 1, wherein said adjustable orifice plate includes four orifices of differing sizes for adjusting the flow of nourishment or medication into said nipple depending upon the viscosity or the desired flow of the nourishment of medication.

3. The adjustable flow infant pacifier according to claim 2, wherein said off-center orifice located in said metering plate is as large or larger than the largest of said four orifices of differing sizes in said adjustable orifice plate.

4. The adjustable flow infant pacifier according to claim 1, wherein said adjustable orifice plate incorporates a lifting tab and said lifting tab is used to raise said adjustable orifice plate for the purpose of rotating said adjustable orifice plate to a different position, thereby adjusting flow through said nipple.

5. The adjustable flow infant pacifier according to claim 4, wherein the total area of said lifting tab is equal to the area of said central cavity in said nipple such that when the pacifier is assembled said lifting tab will extrude some of the nourishment or medication present therein into said central cavity of said nipple thereby removing all the air in said central cavity of said nipple.

6. The adjustable flow infant pacifier according to claim 1, further including a collapsible bag wherein the nourishment or medication will be placed within said collapsible bag.

7. The adjustable flow infant pacifier according to claim 6, wherein said collapsible bag includes a sealing flange.

8. The adjustable flow infant pacifier according to claim 1, further including a music box removably attached to said male threaded cap section.

9. The adjustable flow infant pacifier according to claim 8, wherein said music box includes a music box cover which houses a battery and incorporates a plurality of speaker orifices.

10. The adjustable flow infant pacifier according to claim 9, wherein said music box cover further incorporates a breather orifice.

11. A method for making an adjustable flow infant pacifier, comprising the steps of:
(a) providing male threaded cap section and a female threaded main body member having a faceplate extending to either side of said faceplate incorporating two breathing orifices and forming a nose relief portion in the forward area said faceplate;
(b) providing a circular shelf with two or more equally spaced angular slots and a central orifice located at the termination of said female threads;
(c) providing a nipple going through the threaded main body member wherein said nipple is displayed with a mounting flange and a tapered opening leading to a central cavity:
(d) providing a circular metering plate having a single off-center orifice located above said nipple and having two or more equally spaced angular shaped locators that register in said two or more equally spaced angular slots in said threaded main body member whereby said metering plate is held in a fixed position; and
(e) providing an adjustable orifice plate having two or more orifices of different sizes capable of flow adjustment by turning said adjustable orifice plate using said lifting tab and lining up the desired orifice in said adjustable orifice plate with said off-center orifice in said metering plate;
whereby said off-center orifice lines up directly with one of the two or more orifices in the adjustable orifice plate when said angular shaped locators are positioned in said angular slots over said metering plate within said threaded main body member.

12. The method for making an adjustable flow infant pacifier according to claim 11, wherein said step of providing an adjustable orifice plate includes the step of providing an adjustable orifice plate wherein said adjustable orifice plate includes four orifices of differing sizes for adjusting the flow of nourishment or medication into said nipple depending upon the viscosity or the desired flow of the nourishment of medication.

13. The method for making an adjustable flow infant pacifier according to claim 12, wherein said step of providing a circular metering plate having a single off-center orifice includes the step of providing a circular metering plate having a single off-center orifice wherein said off-center orifice located in said metering plate is as large or larger than the largest of said four orifices of differing sizes in said adjustable orifice plate.

14. The method for making an adjustable flow infant pacifier according to claim 11, wherein said step of providing an adjustable orifice plate includes the step of providing an adjustable orifice plate wherein said adjustable orifice plate incorporates a lifting tab and said lifting tab is used to raise said adjustable orifice plate for the purpose of rotating said adjustable orifice plate to a different position, thereby adjusting flow through said nipple.

15. The method for making an adjustable flow infant pacifier according to claim 14, wherein said step of providing an adjustable orifice plate wherein said adjustable orifice plate incorporates a lifting tab further includes providing an adjustable orifice plate wherein said adjustable orifice plate incorporates a lifting tab wherein the total area of said lifting tab is equal to the area of said central cavity in said nipple such that when the pacifier is assembled said lifting tab will extrude some of the nourishment or medication present therein into said central cavity of said nipple thereby removing all the air in said central cavity of said nipple.

16. The method for making an adjustable flow infant pacifier according to claim 11, further including the step of providing a collapsible bag wherein the nourishment or medication will be placed within said collapsible bag.

17. The method for making an adjustable flow infant pacifier according to claim 16, wherein said step of providing a collapsible bag further includes the step of providing a collapsible bag wherein said collapsible bag includes a sealing flange.

18. The method for making an adjustable flow infant pacifier according, to claim 11, further including the step of providing a music box removably attached to said male threaded cap section.

19. The method for making an adjustable flow infant pacifier according to claim 18, wherein said step of providing a music box includes the step of providing a music box wherein said music box includes a music box cover which houses a battery and incorporates a plurality of speaker orifices.

20. The method for making an adjustable flow infant pacifier according to claim 19, wherein said step of providing a music box cover includes the step of providing a music box cover wherein said music box cover further incorporates a breather orifice.
